(19) United States
(12) Patent Application Publication
(10) Pub. No.: US 2009/0201421 A1
(43) Pub. Date: Aug. 13, 2009

(54) DATA TRANSMISSION APPARATUS

(76) Inventors: Masahiko Mawatari, Yokohama-shi (JP); Takashi Doi, Tokyo (JP); Hideki Ohkita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/366,922

(22) Filed: Feb. 6, 2009

(30) Foreign Application Priority Data
Feb. 12, 2008 (JP) P2008-031137

(51) Int. Cl. H04N 5/44

(52) U.S. Cl. 348/553; 348/E05.096

(57) ABSTRACT

A data transmission apparatus includes: a communication interface including: a first communication interface receiving first signals transmitted through a communication line having a pair of first and second lines, the first signals being transmitted in opposite phase; and a second communication interface receiving second signals transmitted through the communication line, the second signals being transmitted through the first and second lines in same phase; a signal detector configured to detect an unbalanced signal that appears as one of: a first signal component in the second signals that are received by the second communication interface; and a second signal component in the first signals that are received by the first communication interface; and a notification module configured to notify an occurrence of an unbalance in the communication line when a level of the unbalanced signal detected by the signal detector is equal to or higher than a given value.

### CROSS-REFERENCE TO RELATED APPLICATIONS

This application is based upon and claims the benefit of priority from Japanese Patent Application No. 2008-031137, filed on Feb. 12, 2008, the entire content of which are incorporated herein by reference.

### BACKGROUND

1. Field

One embodiment of the present invention relates to a data transmission apparatus.

2. Description of the Related Art

As an example of a multimedia interface between a video transmission apparatus such as a DVD player or a set-top box, and a video reception apparatus such as a TV receiver or a monitor, there is the HDMI (High Definition Multimedia Interface) standard (see, for example, the document listed below as a related art document). An apparatus having an HDMI output terminal is called a source apparatus, and that having an HDMI input terminal is called a sink apparatus. A video transmission apparatus is a source apparatus, and a video reception apparatus is a sink apparatus. An apparatus which has HDMI output and input terminals, and which has the functions of both source and sink apparatuses is called a repeater apparatus.

Related art document: High-Definition Multimedia Interface Specification Version 1.3a

A communication apparatus which performs communication according to the HDMI standard (hereinafter, such an apparatus is referred to as “HDMI communication apparatus”) has: a TMDS (Transition Minimized Differential Signaling) transmitter which transmits a video image, a sound, and auxiliary information; a +5-V power supply signal (a signal indicative of source ready) transmitter which, in the case where a source apparatus is connected to a sink apparatus or a repeater apparatus, informs the sink apparatus or the repeater apparatus about the connection; an HPD signal transmitter which transmits an HPD (Hot Plug Detect) signal indicating that the sink apparatus or the repeater apparatus is ready for reception of video information (i.e., indicative of sink ready); an EDID transmitter which transmits EDID (Extended Display Identification Data) that are data such as product information of the connected sink apparatus, and suitable video formats; an HDCP (High-bandwidth Digital Content Protection) authentication unit which authenticates the sink apparatus; and a CEC transmitter which transmits an apparatus control signal and a CEC (Consumer Electronics Control) protocol that is a control protocol.

Thus configured HDMI communication apparatus may perform, while inheriting the existing HDMI cable connection and HDMI data transmission, data transmission different from the TMDS transmitter is performed with using an HPD line and an NC (Non-Connect) line which is included in an HDMI cable, but which is an unconnected line.

In the case where, while inheriting the existing HDMI cable connection, new data transmission is performed, however, there is a problem in that, when there arises a situation where data transmission cannot be performed or the transmission quality is poor, it is impossible to determine by the appearance whether the situation is caused by mismatch of the apparatuses or the transmission path connecting the apparatuses together.

### SUMMARY

One of objects of the present invention is to provide a data transmission apparatus in which, while inheriting the existing cable connection, the user can easily determine whether the apparatus is suitable for a new data transmission system or not.

According to a first aspect of the present invention, there is provided a data transmission apparatus including: a communication interface including: a first communication interface configured to receive first signals that are transmitted through a communication line having a pair of first and second lines, the first signals being transmitted through the first and second lines in opposite phase; and a second communication interface configured to receive second signals that are transmitted through the communication line, the second signals being transmitted through the first and second lines in same phase; a signal detector configured to detect an unbalanced signal that appears as one of: a first signal component in the second signals that are received by the second communication interface; and a second signal component in the first signals that are received by the first communication interface; and a notification module configured to notify an occurrence of an unbalance in the communication line when a level of the unbalanced signal detected by the signal detector is higher than a given value.

According to a second aspect of the present invention, there is provided a data transmission apparatus including: a communication interface including: a first communication interface configured to receive first signals that are transmitted through a communication line having a pair of first and second lines, the first signals being transmitted through the first and second lines in opposite phase; and a second communication interface configured to receive second signals that are transmitted through the communication line, the second signals being transmitted through the first and second lines in same phase; a signal detector configured to detect signal level of the first or second signals received by the communication interface; a notification module configured to notify whether or not a counterpart apparatus connected through the communication line is capable of communication by the first or second signals.

According to a third aspect of the present invention, there is provided a data transmission apparatus including: a first communication interface configured to receive first signals that are transmitted through a communication line having a pair of first and second lines, the first signals being transmitted through the first and second lines in opposite phase; a second communication interface configured to receive second signals that are transmitted through the communication line, the second signals being transmitted through the first and second lines in same phase; and a control information communication interface configured to transmit and receives control information through one of the first and second lines, wherein the first and second communication interfaces are configured to transmit at least one of the first and second signals in a predetermined sequence by using transmission or reception timing of the control information as a trigger to perform determination of availability of communication by the first signals, determination of availability of communication by the second signals, and determination of the occurrence of the unbalance in the communication line.

According to a fourth aspect of the present invention, there is provided a data transmission apparatus including: a first communication interface configured to receive first signals that are transmitted through a communication line having a pair of first and second lines, the first signals being transmitted through the first and second lines in opposite phase; a second communication interface configured to receive second signals that are transmitted through the communication line, the second signals being transmitted through the first and second lines in same phase; a first level detector configured to receive the first signals and detects a signal level of the received first signals; and a second level detector configured to receive the second signals and detects a signal level of the received second signals, wherein the first and second communication interfaces are configured to transmit, based on the signal levels of the first and second signals, at least one of the first and second signals at an arbitrary timing in a state where the communication line is not busy in performing communication to perform determination of availability of communication by the first signals, determination of availability of communication by the second signals, and determination of the occurrence of the unbalance in the communication line.

### BRIEF DESCRIPTION OF THE SEVERAL VIEWS OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is an overall view showing an example of a data transmission system of a first embodiment.

FIG. 2 is a block diagram schematically showing the data transmission system of the first embodiment.

FIG. 3 is a schematic diagram partly showing a data transmission path in the first embodiment.

FIG. 4 is a diagram partly showing an information transmission path in the first embodiment shown in FIG. 3.

FIG. 5 is a view showing frequency bands of data transmission in the first embodiment.

FIG. 6A shows examples showing signal wave patterns of transmission signals which are transmitted from a sink apparatus to a source apparatus through communication lines in the first embodiment.

FIG. 6B shows examples showing signal wave patterns of transmission signals which are transmitted from the sink apparatus to the source apparatus through the communication lines in the first embodiment.

FIGS. 7A and 7B show frequency characteristics of the communication line in an HDMI cable, wherein FIG. 7A is a view showing frequency characteristics of the HDMI cable in the first embodiment, and wherein FIG. 7B is a view showing frequency characteristics of a conventional HDMI cable which is a comparative example.

FIG. 8 shows examples of wave patterns of the transmitting signals transmitted through HPD and NC lines of a conventional HDMI cable in which an unbalance occurs.

FIGS. 9A to 9D are views showing display examples of an status indicator disposed in the video reception apparatus.

FIG. 10 is a view showing the manner of displaying an indication that a cable is an unbalanced cable, on the display device of the video reception apparatus.

FIG. 11 is a diagram showing a checking operation which is performed when a DVD recorder and video reception apparatus that are described in the first embodiment are connected to each other through the HDMI cable.

FIG. 12 is a view partly showing another configuration of the information transmission path in the first embodiment.

FIG. 13 is an overall view showing an example of a data transmission system of a second embodiment.

FIG. 14 is a view showing a display on the status indicator disposed in a video reception apparatus of the second embodiment.

FIG. 15 is an overall view showing an example of the data transmission system in the case where the communication line which has been described in the first embodiment does not exist.

FIG. 16 is a diagram showing the configuration of HDMI communication interfaces in a third embodiment.

FIG. 17 is a diagram showing the configuration of an HDMI communication interface in a fourth embodiment.

FIGS. 18A and 18B show the amplitudes of additional- and differential-side receiving signals, FIG. 18A is a view showing the amplitudes before the differential-side receiving signal is corrected, and FIG. 18B is a view showing the amplitudes after the differential-side receiving signal is corrected.

FIG. 19 is a diagram showing the configuration of an HDMI communication interface in a fifth embodiment.

FIG. 20 is a diagram showing the configuration of an HDMI communication interface in a sixth embodiment.

### DETAILED DESCRIPTION

Hereinafter, embodiments of a display apparatus according to the invention will be described in detail with reference to the accompanying drawings.

### First Embodiment

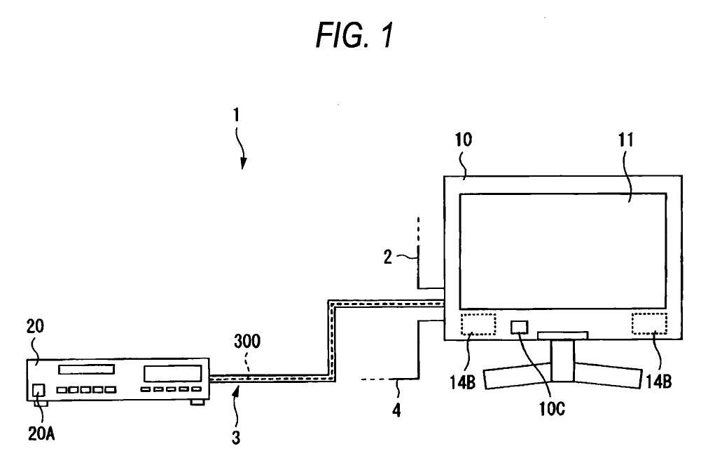

FIG. 1 shows an overall appearance of an example of a data transmission system according to a first embodiment. The data transmission system 1 includes: a video reception apparatus (television receiver) 10 which functions as a sink apparatus in the embodiment; a DVD recorder 20 which functions as a source apparatus; and an HDMI cable 3 through which the video reception apparatus 10 and the DVD recorder 20 are connected to each other, and which enables high-speed bidirectional communication. The HDMI cable 3 has a communication line 300 through which signals of plural frequencies can be transmitted bidirectionally and simultaneously between the sink and source apparatuses at an arbitrary timing. An antenna line 2 connected to an antenna, and an Ethernet (registered trademark) cable 4 connected to an IP (Internet protocol) communication network are connected to the video reception apparatus 10.

The video reception apparatus 10 receives and reproduces video and audio data of a DVD which are reproduced by the DVD recorder 20 and transmitted through the HDMI cable 3. Also, the video reception apparatus outputs a video image and sound based on the television broadcast signal received through the antenna connected to the antenna line 2. Furthermore, the video reception apparatus outputs a video image and sound which are received through the Ethernet (registered trademark) cable 4 and based on IPTV (Internet Protocol Television).

The video reception apparatus 10 is configured so as to transmit at high speed the data of the television broadcast signal, those based on IPTV, and the like to the DVD recorder 20 through the communication line 300 included in the HDMI cable 3.

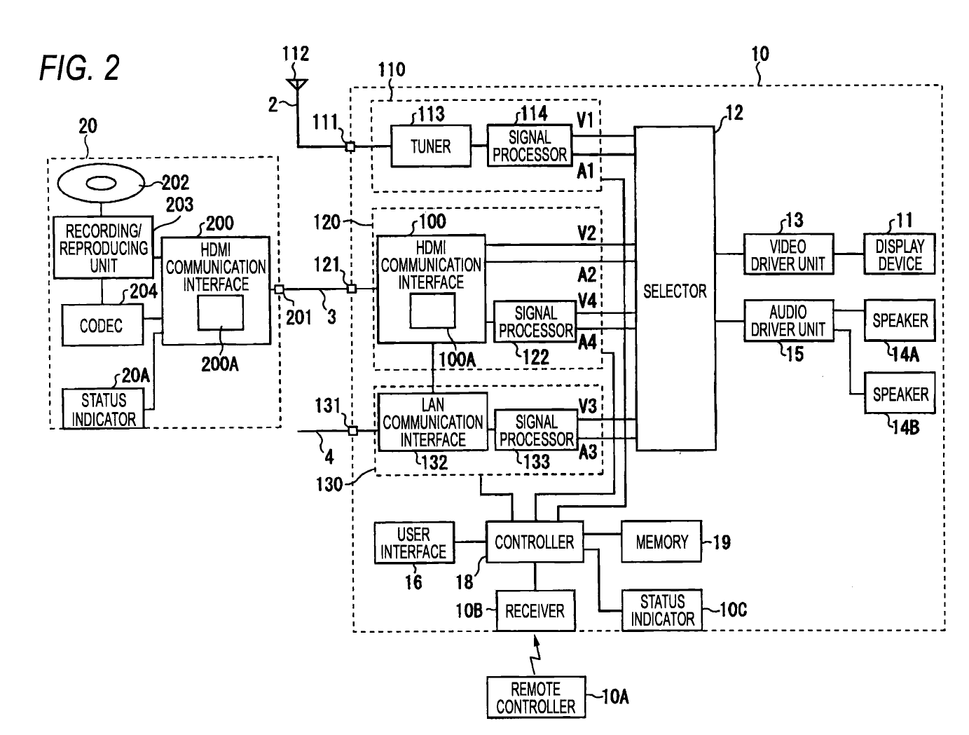

FIG. 2 is a block diagram schematically showing the data transmission system of the first embodiment.

The video reception apparatus 10 is provided with: a television receiver unit 110 which receives the television broadcast signal; an HDMI unit 120 which receives a digital video signal according to the HDMI standard; a LAN (Local Area Network) unit 130 which receives an IPTV transmitted through the Ethernet (registered trademark) cable 4; a selector 12 which selects one of outputs of the television receiver unit 110, the HDMI unit 120, and the LAN unit 130; a receiver 10B which receives a remote control signal that is transmitted from a remote controller 10A based on an input operation of the user; a status indicator 10C which is disposed in the front of the apparatus, and which informs of information of the cable state relating to the suitability of the HDMI cable 3, and the availability of the bidirectional communication of differential and additional signals; a video driver unit 13 which displays a video image on a display device 11 based on a video signal supplied from the selector 12; an audio driver unit 15 which drives speakers 14A, 14B to output s sound based on an audio signal supplied from the selector 12; a user interface 16 on which an input operation is performed based on a manual operation of the user; a controller 18 which overall controls the portions of the video reception apparatus 10; and a memory 19 including a read-only memory which stores control programs to be executed by a CPU of the controller 18, a read/write memory which provides a work area to the CPU, and a nonvolatile memory which stores various kinds of setting information, control information, etc.

The television receiver unit 110 is provided with: a tuner 113 which receives the television broadcast signal received from the antenna 112 connected to a TV (Television) input terminal 111 through the antenna line 2, and which extracts a signal of a predetermined channel; and a signal processor 114 which restores a video signal V1 and an audio signal A1 from the received signal that is supplied from the tuner 113.

The HDMI unit 120 has an HDMI communication interface 100 which is connected to an HDMI terminal 121, and which divides the digital video signal of the HDMI standard that is received from the DVD recorder 20 through the HDMI terminal 121, into video and audio components, and outputs the video component supplied from an HDMI bidirectional communication interface 100A, and the audio component supplied from the HDMI communication interface 100, as V2 and A2, respectively. The HDMI unit 120 further has a signal processor 122 which divides the video signal based on the differential signal received by the bidirectional communication interface 100A disposed in the HDMI communication interface 100, into video and audio components, and which outputs the components as V4 and A4, respectively. The bidirectional communication interface 100A is configured so as to output the signal (additional signal) which is transmitted together with the above-described differential signal through the communication line 300 that will be described later, while separated from the differential signal. The HDMI cable 3 which is connected to an HDMI terminal 201 of the DVD recorder 20, and which functions as a digital transmission bus is connected to the HDMI terminal 121.

The LAN unit 130 has: a LAN communication interface 132 which receives an IPTV broadcast signal through the Ethernet (registered trademark) cable 4 connected to a LAN terminal 131, and which extracts a signal of a predetermined channel; and a signal processor 133 which restores a video signal V3 and an audio signal A3 from the received signal that is supplied from the LAN communication interface 132.

The selector 12 has functions of selectively switching over the analog video and audio signals V1, A1 supplied from the television receiver unit 110, the analog video and audio signals V2, A2 supplied from the HDMI unit 120, and the analog video and audio signals V3, A3 supplied from the LAN unit 130, and outputting the selected signals to the video driver unit 13 and the audio driver unit 15.

The DVD recorder 20 has: an HDMI communication interface 200 including a bidirectional communication interface 200A which performs high-speed bidirectional data transmission with respect to the HDMI communication interface 100 of the video reception apparatus 10 through the HDMI cable 3 connected to the HDMI terminal 201; a recording/reproducing unit 203 which performs recording and reproducing processes on a recording medium 202 such as a DVD; a codec 204 which MPEG-decodes encoded data supplied from the recording/reproducing unit 203 to video and audio signals of a base band, and which supplies the base band video and audio signals to the HDMI communication interface 200; and an status indicator 20A which informs of the information of the cable state relating to the suitability of the HDMI cable 3, and the availability of the bidirectional communication of the differential and additional signals. The recording/reproducing unit 203 is configured to be able to record encoded data supplied from the codec 204, and those supplied from the HDMI communication interface 200.

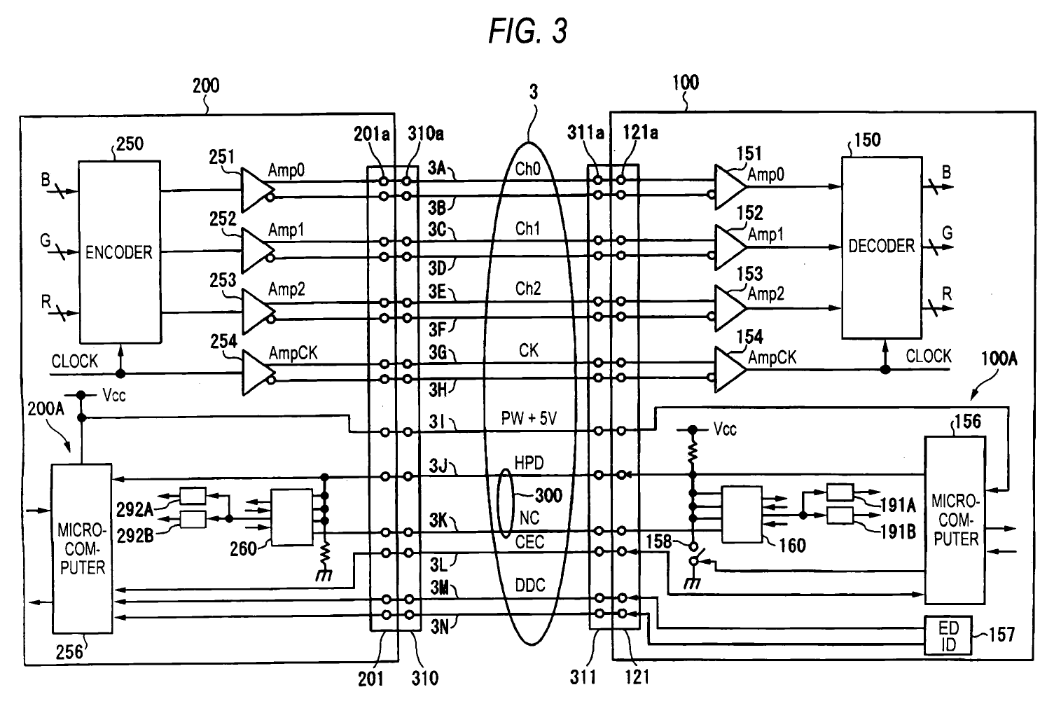

FIG. 3 is a schematic diagram partly showing a data transmission path in the first embodiment.

In the embodiment, the data transmission path through which the source apparatus is connected to the sink apparatus is configured by the HDMI communication interface 200, the HDMI cable 3, and the HDMI communication interface 100. The data transmission path is configured by: a high-speed digital transmission path through which video signals including video and audio components are transmitted by three TMDS channels (Ch0, Ch1, Ch2) from the source apparatus to the sink apparatus, and a pixel clock signal synchronized with pixel data transmitted by the three TMDS channels is transmitted by a CK channel; and an information transmission path configured by plural signal lines such as a PW-+5V line indicating the cable connection state, an HPD line, a CEC line for controlling the state of the apparatuses, and a DDC lines for transmitting EDIC information.

The HDMI communication interface 200 is provided with a microcomputer 256 which authenticates whether the sink apparatus has the authority to receive the video signal or not, and a transmitting/receiver 260 which is a communication interface for performing the bidirectional data transmission with respect to a transmitting/receiver 160 disposed in the HDMI communication interface 100.

In the HDMI communication interface 100, disposed are an EDID memory 157 for storing EDID indicating information of types of video images which can be displayed on the video reception apparatus that is a sink apparatus in the embodiment, a switch 158 which is driven by a microcomputer 156 to switch over H (High) and L (Low) levels of an HPD line 3J, and the transmitting/receiver 160 which is a communication interface for performing the bidirectional data transmission with respect to the transmitting/receiver 260 disposed in the HDMI communication interface 200.

The high-speed digital transmission path has: an encoder 250 which encodes 8-bit RGB video signals supplied from the source apparatus to 10-bit serial data; differential amplifiers 251 to 253 which convert the encoded 10-bit RGB serial data to differential signals, a differential amplifier 254 which converts the pixel clock signal to differential signals; differential signal lines 3A to 3H through which the differential signals output from the differential amplifiers 251 to 254 are transmitted; differential amplifiers 151 to 154 which receive the differential signals transmitted through the differential signal lines 3A to 3H, on the side of the sink apparatus, and which decode the signals to 10-bit serial data; and a decoder 150 which decodes the 10-bit serial data to the 8-bit video signals.

The information transmission path has: a PW-+5V line 3I through which a power supply of the source apparatus is connected to the microcomputer 156; the HPD line 3J which is connected between the transmitting/receiver 260 of the source apparatus and the transmitting/receiver 160 of the sink apparatus, to transmit the connection state of the sink apparatus to the source apparatus; an NC line 3K which cooperates with the HPD line 3J to transmit the differential and additional signals between the source and sink apparatuses; a CEC line 3L through which information for mutually connecting the apparatuses is transmitted; and DDC lines 3M, 3N through which data required in the HDCP authentication are transmitted with respect to the sink apparatus.

The term “additional signal” as used in the specification refers to a signal which is bidirectionally transmitted between the source and sink apparatuses through the HPD line 3J and the NC line 3K, and in which the signal component of the HPD line 3J and that of the NC line 3K are in phase. By contrast, the differential signal refers to a signal in which the signal component of the HPD line 3J and that of the NC line 3K are in opposite phase.

The HPD and NC lines 3J, 3K constitute the communication line 300 which is formed by twisted pair lines or the like, and function as a bidirectional digital transmission path for transmitting a differential signal based on a frame according to IEEE (Institute of Electrical and Electronics Engineers) 802.3 and an additional signal based on CEA 60958 (so-called S/PDIF (Sony/Philips Digital Interface Format)) standard, between the source and sink apparatuses. The data transmission using the communication line 300 may be performed by another transmission system other than the above-described transmission system.

The HDMI cable 3 is disposed so that terminals 310a to 310n and 311a to 311n which are disposed in connectors 310, 311 correspondingly with the lines are electrically connected to terminals 201a to 201n and 121a to 121n of the HDMI terminals 201, 121, respectively.

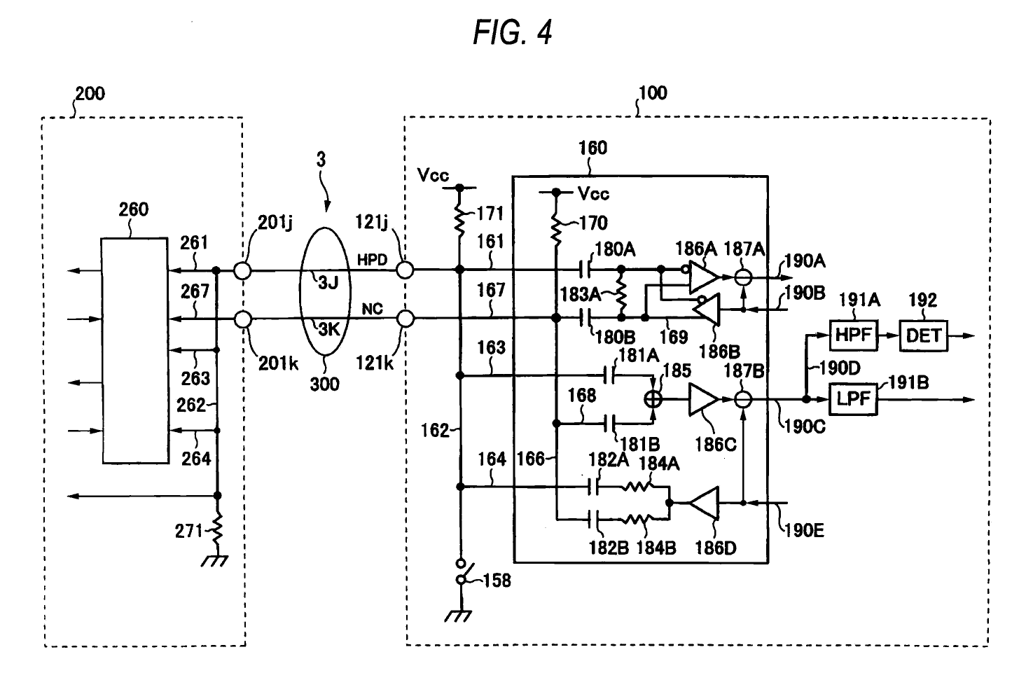

FIG. 4 is a diagram partly showing an information transmission path in the first embodiment shown in FIG. 3.

In the transmitting/receiver 160 on the side of the sink apparatus, a signal line 161 which is connected to the terminal 121j of the HDMI terminal 121 is connected to the HPD line 3J of the HDMI cable 3. The signal line 161 is connected to a signal line 162 which is disposed outside the transmitting/receiver 160, and the signal line 162 is connected to a power supply Vcc via a resistor 171. A signal line 167 which is connected to a terminal 121k of the HDMI terminal 121 is connected to the NC line 3K of the HDMI cable 3. The signal line 167 is connected to a signal line 166 which is disposed inside the transmitting/receiver 160, and the signal line 166 is connected to the power supply Vcc via a resistor 170.

A capacitor 180A is connected to the signal line 161, and a capacitor 180B to the signal line 167. The signal lines 161, 167 are connected to each other via a resistor 183A, and connected respectively to a receiving amplifier 186A and a transmitting amplifier 186B. A subtractor 187A which functions as an echo canceller during differential communication is disposed in a signal line 190A that is connected to the receiving amplifier 186A. The subtractor 187A is connected to a signal line 190B that is connected to the transmitting amplifier 186B.

The signal line 162 is connected to a signal line 163 to which a capacitor 181A is connected. The signal line 166 is connected to a signal line 168 to which a capacitor 181B is connected. The signal lines 163, 168 are connected to an adder 185. The adder 185 is connected to a receiving amplifier 186C. A subtractor 187B which functions as an echo canceller during additional communication is disposed in a signal line 190C that is connected to the receiving amplifier 186C. The subtractor 187B is connected to a signal line 190E that is connected to a transmitting amplifier 186D.

The signal line 162 is connected to a signal line 164 to which a capacitor 182A and a resistor 184A are connected. A capacitor 182B and a resistor 184B are connected to the signal line 166. The signal lines 164, 166 are connected to the transmitting amplifier 186D.

In the transmitting/receiver 160, the signal line 190A functions as an output line of differential communication, the signal line 190B as an input line of differential communication, the signal line 190C as an output line of additional communication, the signal line 190E as an input line of additional communication, and the receiving amplifier 186A and the transmitting amplifier 186B constitute a differential communication interface (first communication interface). The receiving amplifier 186C and the transmitting amplifier 186D constitute an additional communication interface (second communication interface). Transmitting signals which are transmitted through the communication line 300 are added to each other in the adder 185, and then supplied to the receiving amplifier 186C to be supplied to the signal line 190C as an additional-side receiving signal. The additional-side receiving signal is passed through an LPF (Low-pass filter) 191B, whereby a low-band signal (for example, an S/PDIF signal) is separated. A signal line 190D is connected to the signal line 190C. The signal line 190D has an HPF (High-pass filter) 191A which separates high-band components that are superimposed on the transmitting signals as a differential unbalance signal, and a signal detector 192 which detects the separated high-band components as a differential unbalance detection signal.

The term “unbalance” as used in the specification means that the frequency characteristics of the HPD and NC lines 3J, 3K constituting the communication line 300 of the HDMI cable 3 are different from each other, and the term “differential unbalance detection signal” refers a signal which, even when differential signal components of the HPD line 3J and the NC line 3K are added to each other, does not become zero and remains to exist because the frequency characteristics of the HPD and NC lines 3J, 3K constituting the communication line 300 are different from each other.

The transmitting/receiver 260 of the HDMI communication interface 200 disposed on the side of the DVD recorder 20 has the same configuration as the transmitting/receiver 160, except that a signal line 261 connected to the HDMI terminal 201j is connected of the HPD line 3J of the HDMI cable 3, also to signal lines 263, 364 through a signal line 262, and grounded via a resistor 271, and a signal line 267 connected to the HDMI terminal 201k is connected of the HPD line 3J of the HDMI cable 3. Therefore, duplicated description will be omitted.

The signal lines 161, 167 in the transmitting/receiver 160 constitute differential signal lines which are paired to perform differential transmission, and are electrically connected to the receiving amplifier 186A and transmitting amplifier 186B which constitute the differential communication interface, thereby performing data transmission through the HPD and NC lines 3J, 3K of the HDMI cable 3.

In the transmitting/receiver 160, the signal lines 162, 163, and the signal lines 166, 168 configure additional signal lines, and the signal lines 163, 168 on the reception side are configured so that the additional signal which is obtained by the addition in the adder 185 is supplied to the receiving amplifier 186C. The signal lines 164, 166 on the transmission side are configured so that the transmission signals which are output from the transmitting amplifier 186D, and which are in phase are supplied to the lines, respectively. The additional signal lines on the reception and transmission sides are connected to the signal lines 161, 167 which constitute the differential signal lines.

The switch 158 is driven by the microcomputer 156 which has been described with reference to FIG. 3. The signal level of the HPD line 3J is switched from the H level to the L level or from the L level to the H level by the operation of the switch 158. The output level of the HPD signal is changed by the operation pattern of the switch 158 as shown in Table 1.

TABLE 1

| | | Switch |
|---|---|---|
| | | 158 |
| HPD signal | H | OFF |
| | L | ON |

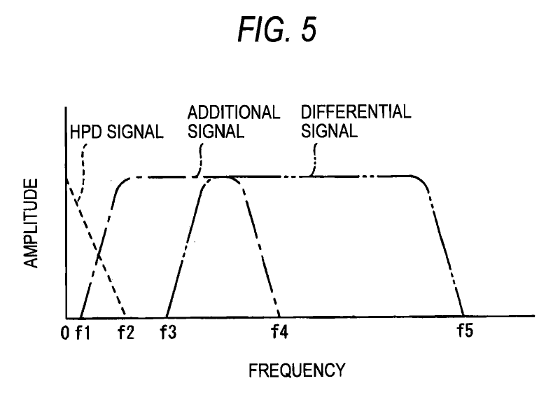

FIG. 5 is a view showing frequency bands of data transmission in the first embodiment. In the embodiment, an S/PDIF signal functioning as the additional signal and having a frequency band of f1 to f4, and a video signal functioning as the differential signal and having a frequency band of f3 to f5 are bidirectionally transmitted through the HPD and NC lines 3J, 3K, and the frequency bands of the additional and differential signals partly overlap with each other. Although the HPD line 3J is used for transmitting the HPD signal, for example, the HPD signal has a frequency band extending from DC to f2.

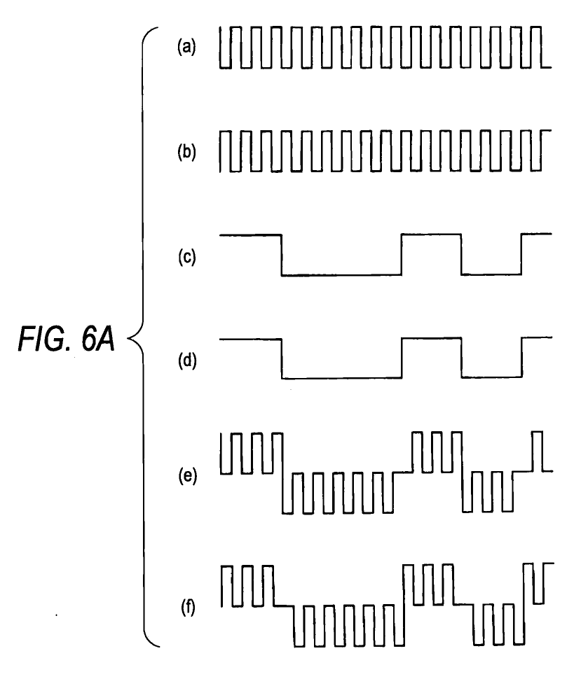

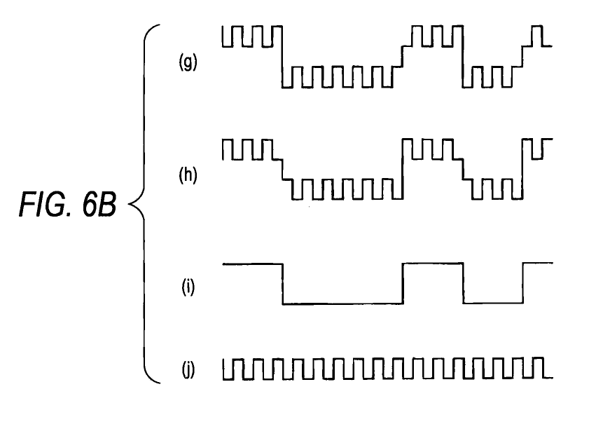

In FIG. 6A, sections (a) to (f) are views showing signal wave patterns of transmission signals which are transmitted from the sink apparatus to the source apparatus through the communication lines in the first embodiment. The views of sections (a) and (b) show the differential signal functioning as a high-band signal, wherein section (a) shows the signal wave pattern of the plus side of the transmitting amplifier 186B, and section (b) shows the signal wave pattern of the minus side of the transmitting amplifier 186B. The views of sections (c) and (d) show the additional signal functioning as a low-band signal, wherein section (c) shows the signal wave pattern output from the transmitting amplifier 186D to the signal line 164, and section (d) shows the signal wave pattern output from the transmitting amplifier 186D to the signal line 166. The view of section (e) shows the wave pattern of the signal which is output to the signal line 167, and which is obtained by adding the differential signal shown in section (a) and the additional signal shown in section (c) together. The view of section (f) shows the wave pattern of the signal which is output to the signal line 161, and which is obtained by adding the differential signal shown in section (b) and the additional signal shown in section (d) together.

In FIG. 6B, sections (g) to (j) are views showing signal wave patterns of transmission signals which are transmitted from the sink apparatus to the source apparatus through the communication lines in the first embodiment. The view of section (g) shows the wave pattern of the receiving signal corresponding to section (e) of FIG. 6A, and section (h) shows the wave pattern of the receiving signal corresponding to section (f) of FIG. 6A. The signal wave pattern shapes of sections (g) and (h) of FIG. 6B are different from those of sections (e) and (f) of FIG. 6A because of the attenuation in the transmission of the transmission signals through the communication line 300. When the frequency characteristics of the HPD and NC lines 3J, 3K constituting the communication line 300 are identical to each other and the balance is attained, differential signal components are removed by adding the signals of the HPD and NC lines 3J, 3K together, thereby obtaining the additional signal component shown in section (i), and, as shown in section (j), additional signal components are removed by subtracting the signals of the HPD and NC lines 3J, 3K to obtain differential signal components.

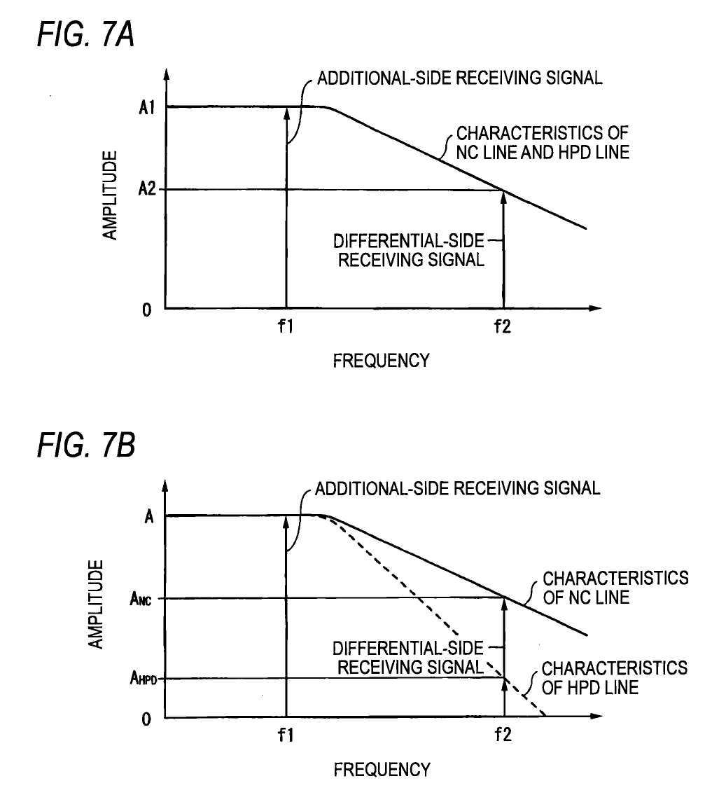

FIGS. 7A and 7B show frequency characteristics of the communication line in the HDMI cable, wherein FIG. 7A is a view showing frequency characteristics of the HDMI cable in the first embodiment, and FIG. 7B is a view showing frequency characteristics of a conventional HDMI cable which is a comparative example.

The signal transmission in the first embodiment exhibits a tendency that, as the frequency is higher, the amount of signal attenuation is larger and the amplitude is smaller. As shown in FIG. 7A, therefore, the amplitude of the differential-side receiving signal at frequency f2 is reduced as compared to that of the additional-side receiving signal at frequency f1.

In the case where the HPD and NC lines 3J, 3K constituting the communication line 300 in the first embodiment are twisted pair lines, the balance is attained, and, as shown in FIG. 7A, the amplitudes of the transmitting signals both in the HPD and NC lines 3J, 3K are therefore reduced in a similar manner. The frequencies f1, f2 are typical exemplified frequencies of the frequency bands of the receiving signals on the additional and differential sides.

By contrast, when an unbalance occurs between the HPD and NC lines of the communication line, for example, the amount of signal attenuation in a high band of the HPD line is larger than that in a high band of the NC line. As shown in FIG. 7B, at the frequency f2, the transmitting signal transmitted through the HPD line 3J has an amplitude A_{HPD} in contrast to that the transmitting signal transmitted through the NC line 3K has an amplitude A_{NC}, with the result that an amplitude difference (A_{NC}−A_{HPD}) occurs in the differential-side receiving signals.

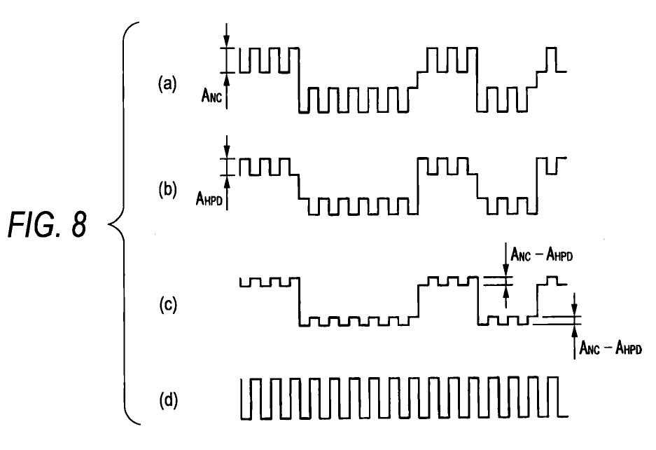

In FIG. 8, sections (a) to (d) are views showing examples of wave patterns of the transmitting signals transmitted through HPD and NC lines of a conventional HDMI cable in which an unbalance occurs, wherein section (a) shows the signal wave pattern of the NC line, section (b) shows the signal wave pattern of the HPD line, section (c) shows the signal wave pattern of an additional signal which is obtained by adding the transmitting signals sections (a) and (b) together, and section (d) shows the signal wave pattern of a differential signal which is obtained by subtracting the transmitting signals shown in sections (a) and (b).

When an unbalance occurs between the HPD and NC lines, the transmitting signal of the NC line shown in section (a) and that of the HPD line shown in section (b) are not in completely opposite phase relationship. When the two transmitting signals are added to each other by an adder (for example, the adder 185 of the transmitting/receiver 160), therefore, the component of the differential signal does not become zero but remains. The remaining signal component is the differential unbalance signal corresponding to the degree of the unbalance (A_{NC}−A_{HPD}), and appears in the form where the component is superimposed on the additional signal.

In the first example, the example in which, as shown in FIGS. 5-8, the differential signal is placed on the high-band side, and the additional signal on the low-band side has been described. The placement relationship of the frequencies is not limited to this. The differential signal may be placed on the low-band side, and the additional signal on the high-band side depending on the characteristics of a cable. There is a case where an unbalance occurs also in the frequency band on the low-band side. In such a case, the additional signal component leaks into the differential receiving signal shown in section (d) of FIG. 8, and therefore the component may be detected.

Next, the operation of the data transmission system of the first embodiment will be described with reference to the drawings with respect to data transmission from the DVD recorder 20 to the video reception apparatus 10.

First, the transmitting signal in which the differential signal and the additional signal are added together is output from the transmitting/receiver 260 of the source apparatus shown in FIG. 4 through the communication line 300 of the HDMI cable 3. Then, the transmitting signal is supplied to the signal lines 161, 167 through the HDMI terminals 121j, 121k of the HDMI communication interface 100.

The transmitting signal is input into the receiving amplifier 186A through the signal line 161 and the signal lines 167, 169. The receiving amplifier 186A separates the additional signal from the two transmitting signals which are supplied through the HPD line 3J and the NC line 3K, to extract the differential signal. The differential signal is amplified so as to have a predetermined amplitude, and then output. The amplified signal is output as the differential-side receiving signal to the signal line 190A through the subtractor 187A.

The transmitting signal is input also into the adder 185 through the signal lines 162, 163 and the signal lines 167, 169. The adder 185 adds the two transmitting signals which are supplied through the HPD line 3J and the NC line 3K, thereby separating the differential signal to extract the additional signal. The separated additional signal is supplied to the receiving amplifier 186C. The receiving amplifier 186C amplifies the additional signal so as to have predetermined amplitude, and then output the amplified signal. The amplified signal is supplied as the additional-side receiving signal to the signal line 190C through the subtractor 187B.

The LPF 191B disposed in the signal line 190C allows the component of a predetermined low-frequency band included in the additional-side receiving signal, to pass therethrough.

The additional-side receiving signal is supplied to the HPF 191A disposed in the signal line 190D connected to the signal line 190C. The HPF 191A allows the differential signal component which is a high-band signal superimposed on the additional-side receiving signal, to pass therethrough, and supplies the component to the signal detector 192. When the signal detector 192 detects the differential signal component, the portion supplies the differential unbalance detection signal to the controller 18 shown in FIG. 2. Based on the input of the differential unbalance detection signal, the controller 18 controls the status indicator 10C shown in FIG. 1 to display an indication that the HDMI cable 3 is an unbalanced cable.

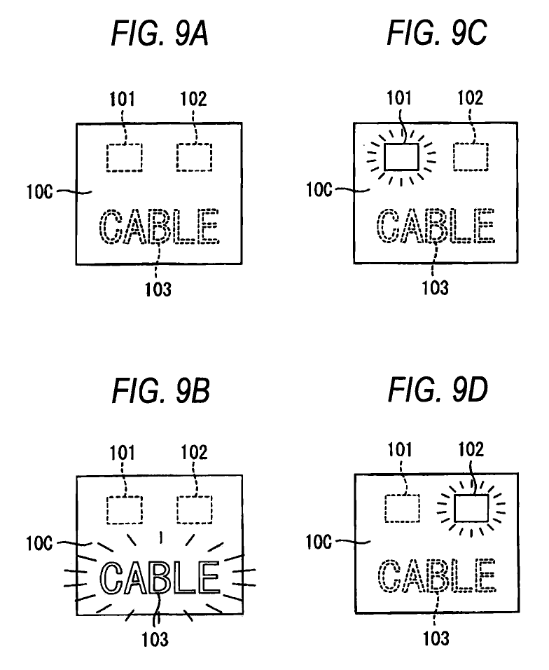

FIGS. 9A to 9D are views showing display examples of the status indicator disposed in the video reception apparatus. The status indicator 10C has a differential communication disabled indicator 101, an additional communication disabled indicator 102, and an unbalanced cable indicator 103, and is formed so that the display is usually invisible as shown in FIG. 9A, and, when a corresponding display item is lighted on, the display is visible. Display items are lighted in different colors so that a lighted item can be easily identified. Alternatively, the display items may be displayed in different display patterns such as blinking, and the display contents may be informed by means of display and voices emitted from the speaker 14B of the video reception apparatus 10. The status indicator 20A disposed in the DVD recorder 20 is formed in a similar manner as the status indicator 10C. The displays in FIGS. 9C and 9D will be described later.

In the case where the HDMI cable 3 through which the video reception apparatus 10 and the DVD recorder 20 are connected to each other is an unbalanced cable, as shown in FIG. 9B, the indication of “CABLE” indicating that the connected HDMI cable 3 is an unbalanced cable is displayed on the status indicator 10C. The method of informing the user that the cable is an unbalanced cable is not limited to this. For example, the indication may be displayed on the display device 11 of the video reception apparatus 10.

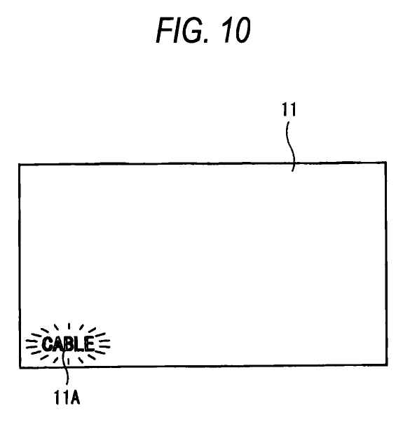

FIG. 10 is a view showing the manner of displaying an indication that the cable is an unbalanced cable, on the display device of the video reception apparatus. Referring to the figure, the video reception apparatus 10 is in the state where the power supply is turned on and the video display on the display device 11 is enabled. In order to facilitate the description, the illustration of the video display is omitted. In FIG. 10, the indication of “CABLE” indicating that the cable is an unbalanced cable is displayed in a lower left portion of the display device 11. The position and manner of the display are not limited to this example.

According to the first embodiment which has been described above, the transmitting/receiver including the differential communication interface and the additional communication interface transmits the transmitting signal in which the differential signal and the additional signal are added to each other, through the communication line of the HDMI cable. When a differential unbalance signal due to an unbalance of the HDMI cable occurs, therefore, the signal is superimposed on the additional-side receiving signal. Consequently, the differential unbalance signal is detected, so that the user can be promptly informed that the HDMI cable is an unbalanced cable which does not satisfy the communication quality.

In the above-described data transmission system 1, it is impossible to distinguish from the appearance whether the HDMI cable 3 through which the video reception apparatus 10 and the DVD recorder 20 are connected to each other is an HDMI cable that realizes bidirectional communication between the source apparatus and sink apparatus and satisfies the communication quality, or an unbalanced cable. When the user selects an arbitrary one of plural HDMI cables 3 possessed by the user to connect together the video reception apparatus 10 and the DVD recorder 20, and then data transmission is performed, for example, a phenomenon such as that a video image is disturbed, or that an audio output is disabled may occur, whereby the user is caused to know that any kind of trouble occurs. However, an average user cannot directly determine that the trouble is caused by the HDMI cable 3. Therefore, the configuration which detects a differential unbalance signal, and which causes the apparatus to display the indication is disposed as described in the first embodiment, so that the suitability of the HDMI cable 3 can be easily determined.

In the first embodiment, with respect to the state of the HDMI cable based on the communication between the DVD recorder 20 and the video reception apparatus 10 through the communication line 300 of the HDMI cable 3, the indication that the cable is an unbalanced cable is displayed on the status indicator 10C of the video reception apparatus 10. The invention is not limited to this. The indication that the cable is an unbalanced cable may be displayed on the status indicator 20A of the DVD recorder 20.

In the first embodiment, each of the source apparatus and the sink apparatus includes the differential communication interface and the additional communication interface. However, apparatuses which are connected to each other through an HDMI cable are not always provided with differential and additional communication interfaces. Therefore, a configuration in which it can check whether apparatuses connected to each other through an HDMI cable are provided with differential and additional communication interfaces or not is more preferable.

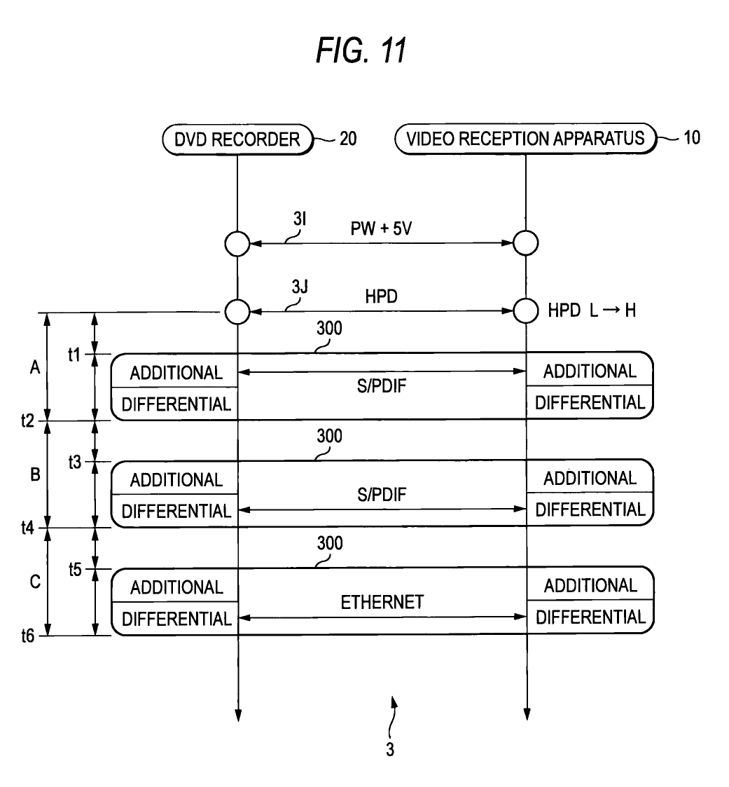

FIG. 11 is a diagram showing a checking operation which is performed when the DVD recorder and video reception apparatus that are described in the first embodiment are connected to each other through the HDMI cable. Hereinafter, the checking operation will be described with reference to FIGS. 3 and 4.

First, the user connects the connector 310 of the HDMI cable 3 to the HDMI terminal 201 of the DVD recorder 20, and the connector 311 of the HDMI cable 3 to the HDMI terminal 121 of the video reception apparatus 10.

Next, based on the connection of the HDMI cable 3, the DVD recorder 20 transmits a PW-+5V signal to the video reception apparatus 10 through the signal line 3I.

Next, in the video reception apparatus 10, based on the input of the PW-+5V signal, the microcomputer 156 changes over the switch 158 from ON to OFF, whereby the signal level of the HPD line 3J is switched from the L level to the H level.

Next, by using as a trigger the timing when the signal level of the HPD line 3J is switched from the L level to the H level, the DVD recorder 20 and the video reception apparatus 10 perform a first test bidirectional communication during a first specified time period A. In the first test bidirectional communication, after an elapse of t1 seconds from the timing when the trigger is generated, an additional signal corresponding to the frequency band of S/PDIF is transmitted through the HDMI cable 3, and the transmission is continued until t2 second.

Next, a second test bidirectional communication is performed during a second specified time period B. At t3 second when a predetermined time period elapses from t2 second, a differential signal corresponding to the frequency band of S/PDIF is transmitted through the HDMI cable 3, and the transmission is continued until t4 second. The differential signal which is transmitted in this communication has the same frequency as the frequency band of S/PDIF which is transmitted in the first test bidirectional communication.

Then, a third test bidirectional communication is performed during a third specified time period C. At t5 second when a predetermined time period elapses from t4 second, a differential signal corresponding to the frequency band of Ethernet (registered trademark) is transmitted through the HDMI cable 3, and the transmission is continued until t6 second.

In the first test bidirectional communication during the first specified time period A, it is possible to check whether an additional communication interface exists or not. In the case where an additional communication interface does not exist, an additional signal is not transmitted from the partner side, and hence the additional communication disabled indicator 102 in the status indicator 10C or 20A is lighted on as shown in FIG. 9D by a controller which is not shown.

In the second test bidirectional communication during the second specified time period B, it is possible to check whether a differential communication interface exists or not. In the case where a differential communication interface does not exist, a differential signal is not transmitted from the partner side, and hence the differential communication disabled indicator 101 in the status indicator 10C or 20A is lighted on as shown in FIG. 9C by the controller which is not shown.

In the second test bidirectional communication during the second specified time period B and the third test bidirectional communication during the third specified time period C, the transmitted signals are known. Therefore, the signal levels are easily compared with each other, and the high-frequency characteristics of the HDMI cable 3 can be checked.

In the third test bidirectional communication during the third specified time period C, it is possible to check the balance characteristics of the HDMI cable 3 based on the amplitude of the differential signal. In the case where, when the differential signals received through the HPD and NC lines 3J, 3K are added to each other, the sum is not zero, the indication of “CABLE” is lighted on as shown in FIG. 9B by the controller which is not shown.

As described above, the HDMI communication interface 100 of the video reception apparatus 10, and the HDMI communication interface 200 of the DVD recorder 20 perform the test bidirectional communications due to the differential or additional signal during the first to third specified time periods, whereby the existence of the communication function and the suitability of the HDMI cable 3 can be checked. With respect to the HDMI cable 3, for example, the degree of the unbalance may be level-displayed based on above-described unbalanced component, on the display device 11 of the video reception apparatus 10. In place of the simultaneous test bidirectional communications with using the HPD signal as a trigger, a test bidirectional communication may be performed in which, in a state where the additional communication and the differential communication are not performed, the additional or differential signal is transmitted as a test signal at an arbitrary timing from one apparatus to another apparatus, and, when the apparatus receiving the signal has the function, a signal of the same frequency band is returned at a predetermined signal level by using the signal as a trigger. In this case, when, after the test signal is transmitted, a received signal level is obtained with respect to the signal of the same frequency band as the test signal, it is possible to determine that the other apparatus reacts to the test signal, and the apparatus has the communication function. Alternatively, one apparatus may transmit a test signal in which the signal pattern is previously determined, and, in response to this, another apparatus may return a test signal in the above-described signal pattern. Alternatively, the return may be performed at a predetermined signal level.

In place of the above-described trigger using the HPD line 3J, for example, a similar trigger signal which allows the trigger operation to be bidirectionally performed by using the NC line 3K may newly defined.

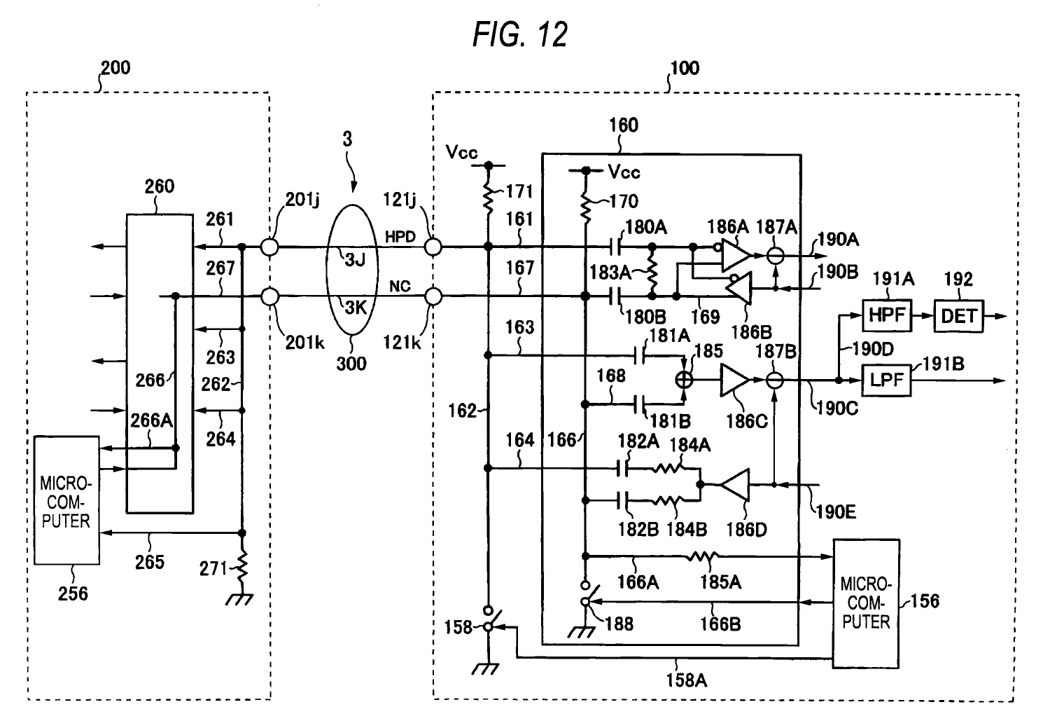

FIG. 12 is a view partly showing another configuration of the information transmission path in the first embodiment. The information transmission path is configured so that the signal line 166 disposed in the transmitting/receiver 160 of the HDMI communication interface 100 shown in FIG. 4 can be grounded through a switch 188. The signal line 166 is connected to the microcomputer 156 through a signal line 166A having a resistor 185A. The microcomputer 156 drives the switch 188 through a signal line 166B. The signal level of the NC line 3K connected to the signal lines 166, 166A is switched from the H level to the L level or from the L level to the H level by an ON/OFF control of the switch 188 by the microcomputer 156. The microcomputer 156 drives also the switch 158 through a signal line 158A.

In the HDMI communication interface 200, the signal line 267 connected to the NC line 3K is connected to the microcomputer 256 through signal lines 266, 266A disposed in transmitting/receiver 260. The signal line 262 connected to the HPD line 3J is connected to the microcomputer 256 through a signal line 265. The transmitting/receivers 160, 260 have the same configuration. In the same manner as the signal lines 166, 166A of the transmitting/receiver 160, therefore, also the signal lines 266, 266A are connected to the microcomputer 256 via a resistor. However, the illustration of the connections is omitted, and only the signal lines of transmitting or receiving the trigger signal are shown.

In this configuration, in the case where the signal level of the NC line 3K is normally set to the H level, when the above-described trigger is to be output, the signal level of the signal line 166 is switched from the H level to the L level, thereby causing the microcomputer 156 to function as a control information communication interface which supplies a trigger signal serving as control information to the NC line 3K. The trigger signal is transmitted to the microcomputer 256 disposed in the HDMI communication interface 200, through the signal lines 266, 266A. In this case, the microcomputer 256 functions as a control information communication interface on the reception side. As described above, based on detection of the reply of the partner side after an elapse of a predetermined time period from the output of the trigger signal, the HDMI communication interfaces 100, 200 may perform test bidirectional transmission. In this case, unlike the system in which the HPD signal is used as a trigger, a trigger signal may be output from the DVD side. In this case, on the transmission side, the trigger signal is output by switching the signal level of the NC line 3K to a predetermined value or lower (from the H level to the L level), and, on the reception side, the output of the trigger signal is recognized by detecting the change of the signal level of the NC line 3K to a predetermined value or lower (from the H level to the L level). The invention is not limited to this. The control information communication interfaces of the transmission and reception sides may previously decide the manner of transmitting the trigger signal.

In FIG. 12, the signal level of the NC line 3K is switched over based on the ON/OFF control of the switch 188. Alternatively, for example, the switch 188 may not be disposed, the signal line 166 may be connected to the microcomputer 156, and the microcomputer 156 may perform a switching operation, thereby switching the signal level of the NC line 3K.

### Second Embodiment

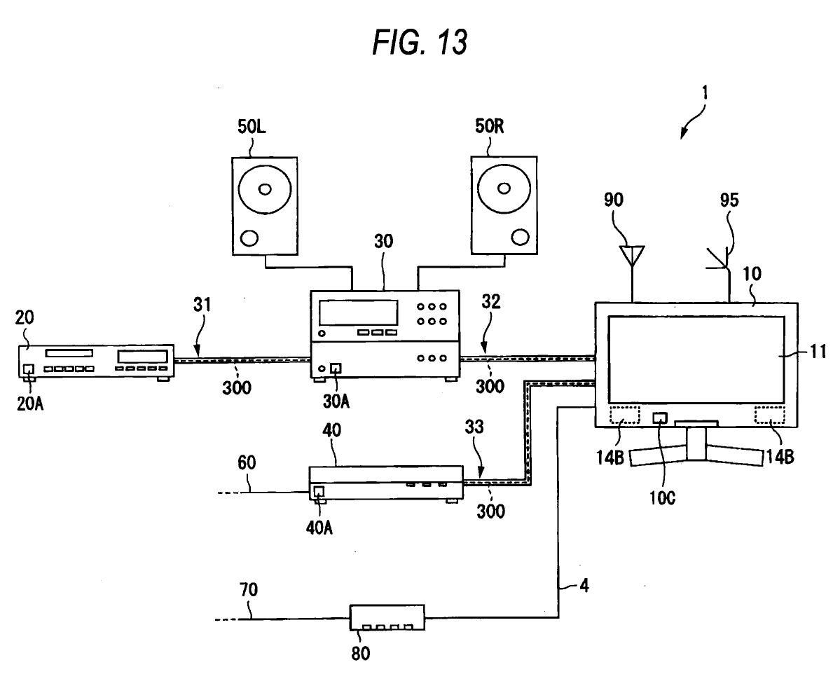

FIG. 13 shows an overall appearance of an example of a data transmission system according to a second embodiment of the present invention. In the second embodiment, a communication circuit between apparatuses is configured in the same manner as the communication circuit which has been described in the first embodiment. In the following description, portions which have the same configuration and function as the first embodiment are denoted by the same reference numerals.

The data transmission system 1 according to the second embodiment is provide with: the video reception apparatus 10; the DVD recorder 20; an AV amplifier 30 which is connected to the video reception apparatus 10 and the DVD recorder 20; speakers 50L, 50R which are connected to the AV amplifier 30; a set-top box 40 which receives a broadcast signal through a cable 60; a modem 80 which is connected to a public line 70, and which is connected to the video reception apparatus 10 through the Ethernet (registered trademark) cable 4; an antenna 90 for allowing the video reception apparatus 10 to receive analog terrestrial broadcasting; and a satellite broadcast antenna 95 for allowing the video reception apparatus 10 to receive satellite broadcasting. The DVD recorder 20 and the AV amplifier 30 are connected to each other through an HDMI cable 31 having the communication line 300 which has been described in the first embodiment. The AV amplifier 30 and the video reception apparatus 10 are connected to each other through an HDMI cable 32 having the communication line 300. The set-top box 40 and the video reception apparatus 10 are connected to each other through an HDMI cable 33 having the communication line 300.

In a similar manner as the apparatuses of the video reception apparatus 10 which has been described in the first embodiment, the AV amplifier 30 and the set-top box 40 have status indicators 30A, 40A which inform of the availability of the bidirectional communication of the differential and additional signals, and an unbalance of the HDMI cable, in their front portions, respectively.

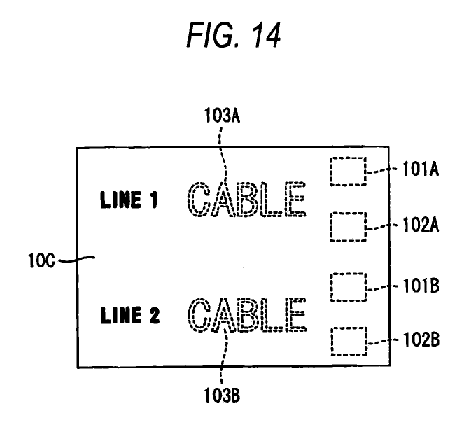

FIG. 14 is a view showing a display on the status indicator disposed in the video reception apparatus of the second embodiment. The video reception apparatus 10 of the second embodiment has two HDMI terminals and two HDMI communication interfaces, and hence the status indicator 10C is configured so as to be able to perform displays respectively corresponding to the two HDMI terminals. In the figure, correspondingly with two systems (LINE 1 and LINE 2), differential communication disabled indicators 101A, 101B, and additional communication disabled indicators 102A, 102B, and unbalanced cable indicators 103A, 103B are disposed. In the second embodiment, LINE 1 is the side to which the AV amplifier 30 is connected, and LINE 2 is the side to which the set-top box 40 is connected.

Hereinafter, the case where, in the data transmission system 1, a DVD is reproduced by the DVD recorder 20, a video image is displayed on the display device 11 of the video reception apparatus 10, and a sound is output from the speakers 50L, 50R connected to the AV amplifier 30 will be described.

The DVD recorder 20 supplies a reproduced video signal of the DVD to the AV amplifier 30 through the HDMI cable 31. The AV amplifier 30 transmits the video signal which is transmitted in the form of a serial data from the DVD recorder 20, to the video reception apparatus 10 through the HDMI cable 32, and further supplies an analog audio signal which is extracted from the serial data, and obtained by decoding, to the speakers 50L, 50R. In the system configuration, the AV amplifier 30 adjusts the sound volume and the like, thereby enabling an audio output producing a sense of presence in accordance with the video image displayed on the display device 11 of the video reception apparatus 10.

Next, a case where the video reception apparatus 10 receives a television broadcast signal, and the audio signal is to be output from the speakers 50L, 50R via the AV amplifier 30 will be described.

In the data transmission system 1, the audio signal of the video reception apparatus 10 is transmitted as an S/PDIF signal to the AV amplifier 30 through the communication line 300 of the HDMI cable 32. The video reception apparatus 10 and the AV amplifier 30 have a transmitting/receiver including differential and additional communication interfaces, and the S/PDIF signal is transmitted through the communication line 300 as the additional signal which has been described in the first embodiment. The AV amplifier 30 converts the S/PDIF signal transmitted through the communication line 300 to an analog audio signal, and supplies the audio signal to the speakers 50L, 50R.

In the case where the HDMI cable 32 through which the AV amplifier 30 and the video reception apparatus 10 are connected to each other is an unbalanced cable, the indication of “CABLE” indicating an unbalanced cable is displayed on the side of LINE 1 of the status indicator 10C of the video reception apparatus 10. Alternatively, the indication of “CABLE” may be displayed on the status indicator 30A of the AV amplifier 30, or on the status indicators 10C, 30A.

In accordance with the indication on the status indicator 10C, the user replaces the unbalanced cable with the HDMI cable 31 corresponding to bidirectional communication. After the replacement, the transmitting/receivers 160, 260 disposed in the both apparatuses communicate with the apparatus connected to the cable, to check the existence of the differential and additional communication interfaces, and the suitability of the HDMI cable. When additional and differential communications are enabled and the HDMI cable is suitable for bidirectional communication, the status indicators 10C, 30A are set to a non-indicated state.

Between the set-top box 40 and the video reception apparatus 10, in the same manner as the case of the AV amplifier 30 and the video reception apparatus 10, the existence of the differential and additional communication interfaces, and the suitability of the HDMI cable are checked.

In the above description, the transmission of the audio signal has been described. In the second embodiment, the video reception apparatus 10 and the AV amplifier 30 have the transmitting/receivers 160, 260 including differential and additional communication interfaces, and hence signals of a high-frequency band such as the video and audio signals which are supplied from the modem 80 to the video reception apparatus 10 through the Ethernet (registered trademark) cable 4A can be transmitted, for example, to the AV amplifier 30 and the DVD recorder 20 via the video reception apparatus 10 without lowering the communication quality. In addition to signals such as the video signal, for example, an operation signal of the remote controller 10A shown in FIG. 2 may be transmitted to the AV amplifier 30 and the DVD recorder 20, to control these apparatuses.

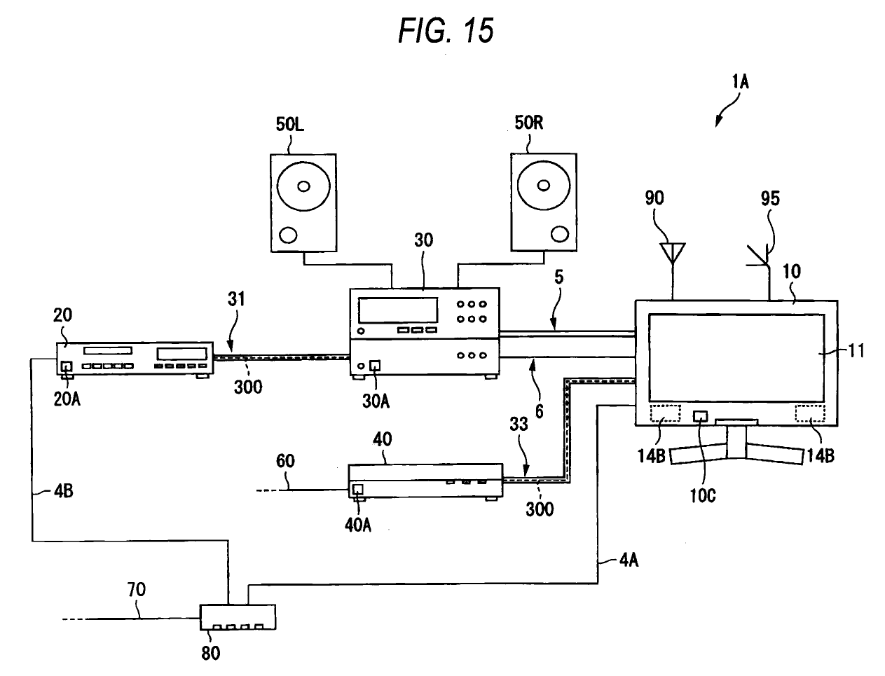

FIG. 15 is an overall view showing an example of the data transmission system in the case where the communication line which has been described in the first embodiment does not exist.

In the data transmission system 1A shown in FIG. 15, the video reception apparatus 10 and the AV amplifier 30 are connected to each other by a usual HDMI cable 5 in place of the HDMI cable 32 which has been described with reference to FIG. 13, and an S/PDIF cable 6 through which the audio signal is transmitted from the video reception apparatus 10 to the AV amplifier 30 is disposed. An Ethernet (registered trademark) cable 4B is connected between the DVD recorder 20 and the modem 80.

In the data transmission system 1A, the audio signal of the video reception apparatus 10 is transmitted to the AV amplifier 30 through the S/PDIF cable 6. Therefore, at least two cables are required between the video reception apparatus 10 and the AV amplifier 30. The high-frequency band signals such as the video and audio signals which are supplied to the video reception apparatus 10 through the Ethernet (registered trademark) cable 4A cannot be transmitted to the AV amplifier 30. In order that the DVD recorder 20 receives the high-frequency band signals such as the video and audio signals, therefore, the Ethernet (registered trademark) cable 4B must be connected between the recorder and the modem 80. Therefore, the number of cables is increased, and the connection is complicated.

According to the second embodiment which has been described above, the video reception apparatus 10, the DVD recorder 20, the AV amplifier 30, and the set-top box 40 are connected to one another by the HDMI cables 31, 32, 33 having the communication line 300 which can perform bidirectional communication. In addition to the preferred effects of the first embodiment, therefore, signals of a broad band extending from the low-frequency band to the high-frequency band can be bidirectionally transmitted at high speed at an arbitrary timing while preventing the connection from being complicated.

### Third Embodiment

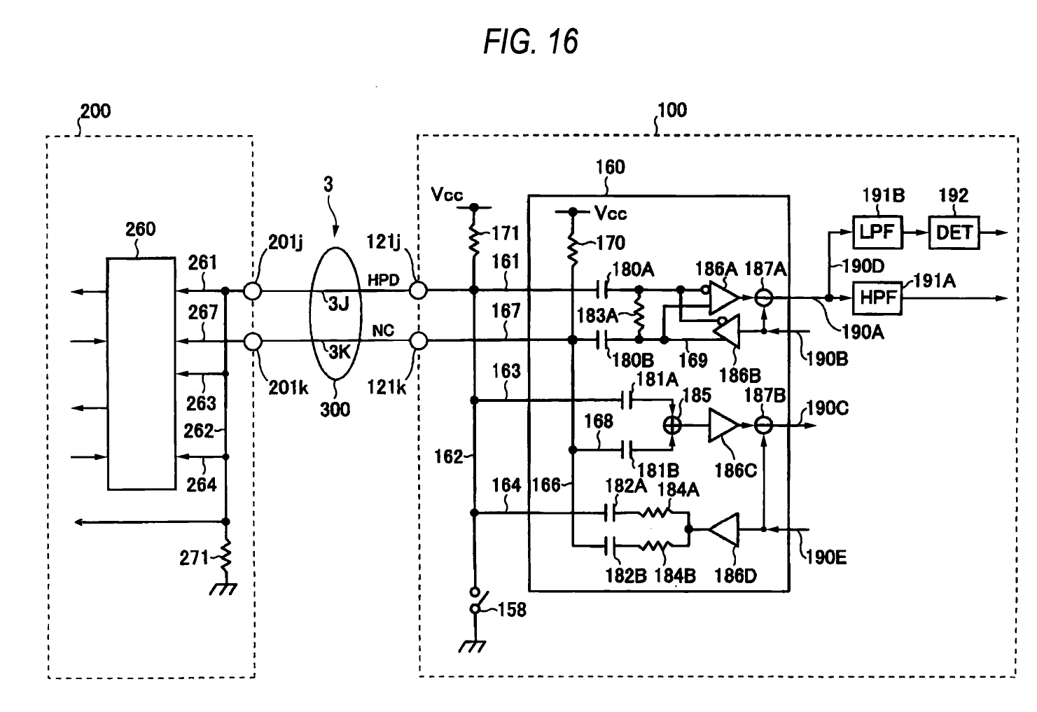

FIG. 16 is a diagram showing the configuration of HDMI communication interfaces in a third embodiment. When an unbalance occurs in the frequency band (low-frequency band) of the additional communication, the HDMI communication interfaces 100, 200 can detect this.

The third embodiment has a configuration in which the HPF 191A is disposed in the signal line 190A of the transmitting/receiver 160 disposed in the HDMI communication interface 100 which has been described in the first embodiment, and the LPF 191B and the signal detector 192 are disposed in the signal line 190D connected to the signal line 190A.

The HPF 191A allows the differential-side receiving signal component which is output from the receiving amplifier 186A, to pass therethrough, thereby separating high-band components.

The LPF 191B separates low-band components that are superimposed as an additional unbalance signal on the output signal from the amplifier. The signal detector 192 detects the separated low-band components as an additional unbalance detection signal.

According to the third embodiment which has been described above, also with respect to an HDMI cable in which an unbalance occurs in the low-frequency band, an additional unbalance detection signal can be detected. The detection of an additional unbalance detection signal enables the user to be promptly informed that the HDMI cable is not suitable.

Also in the HDMI communication interfaces in the third embodiment, when the first to third test bidirectional communications which have been described in the first embodiment are performed, it is possible to check the existence of the communication function, and the suitability of the HDMI cable 3 in the additional signal band.

### Fourth Embodiment

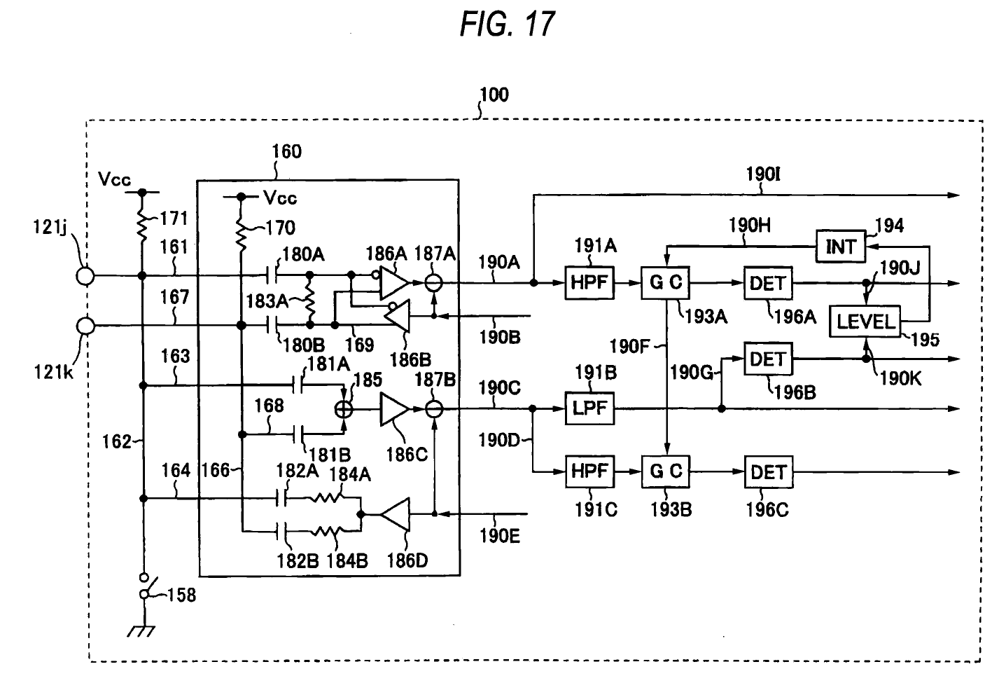

FIG. 17 is a diagram showing a configuration of an HDMI communication interface according to a fourth embodiment. The HDMI communication interface 100 prevents the ability of detecting a differential unbalance signal from being lowered by attenuation of transmitting signals which are transmitted through the communication line 300.

In the fourth embodiment, the HDMI communication interface 100 has in the signal line 190A of the transmitting/receiver 160: the HPF 191A; a gain controller (GC) 193A which corrects the output of the HPF to the same level as the amplitude of the output of the additional-side receiving signal 191B; and a signal detector (DET) 196A which is disposed in the rear of the gain controller (GC) 193A.

In the HDMI communication interface 100, the LPF 191B is disposed in the signal line 190C, and a signal detector (DET) 196B is disposed in a signal line 190G which is connected to the signal line 190C in the rear of the LPF 191B. In the signal line 190D connected to the signal line 190C, an HPF 191C, a gain controller (GC) 193B, and a signal detector (DET) 196C which detects a differential unbalance detection signal that is superimposed on the additional-side receiving signal are disposed.

The outputs of the signal detector (DET) 196A and the signal detector (DET) 196B are output as a receiving signal level. The receiving signal level of the differential-side receiving signal is supplied to a signal comparator (LEVEL) 195 through a signal line 190J which is connected to the signal line 190A in the rear of the signal detector (DET) 196A. The receiving signal level of the additional-side receiving signal is supplied to the signal comparator (LEVEL) 195 through a signal line 190K which is connected to the signal line 190G in the rear of the signal detector (DET) 196B.

The signal comparator (LEVEL) 195 compares the amplitude of the additional-side receiving signal with that of the differential-side receiving signal to output a comparison signal. The comparison signal is supplied to an integrator (INT) 194 disposed in a signal line 190H. The integrator (INT) 194 integrates the comparison signal until the output (amplitude) of the signal detector (DET) 196A becomes equal in level to the output (amplitude) of the signal detector (DET) 196B, and then supplies the integrated signal to the gain controller (GC) 193A. The gain control of the gain controller (GC) 193A is supplied to the gain controller (GC) 193B through a signal line 190F.

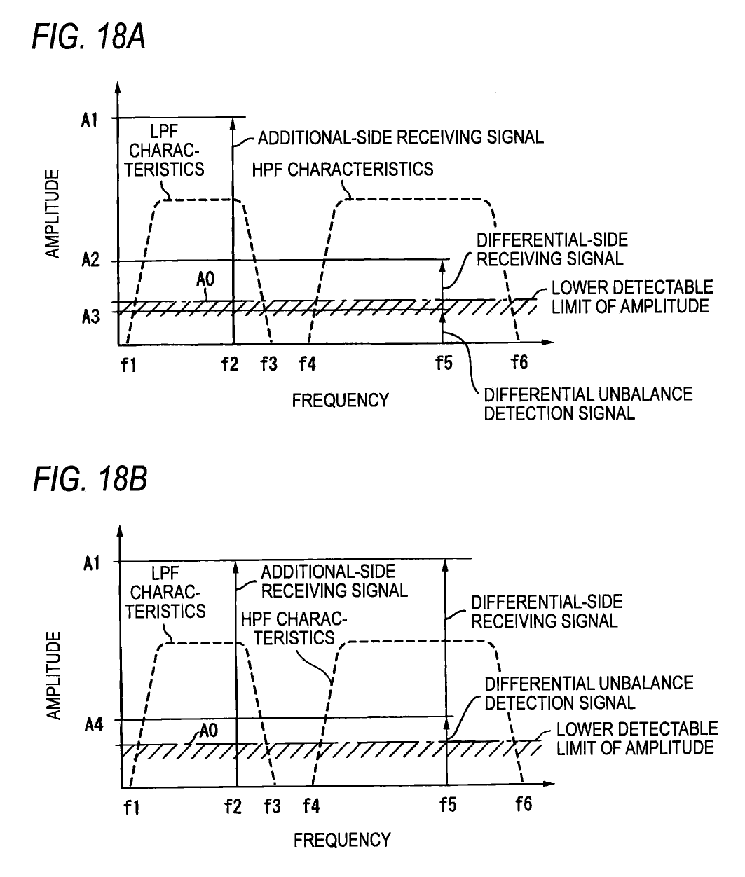

FIGS. 18A and 18B show the amplitudes of the additional- and differential-side receiving signals, FIG. 18A is a view showing the amplitudes before the differential-side receiving signal is corrected, and FIG. 18B is a view showing the amplitudes after the differential-side receiving signal is corrected.

As shown in FIG. 18A, when communication in which the additional and differential signals are added to each other through the HDMI cable is performed, the signals are attenuated, and the amplitude A2 of the differential-side receiving signal which is configured by the high-band components is lower than the amplitude A1 of the additional-side receiving signal which is configured by the low-band components. In the HDMI cable, an unbalance occurs, and the differential unbalance detection signal is superimposed on the differential-side receiving signal. When the amplitude A3 of the differential unbalance detection signal is lower than the lower limit A0 of the amplitude which can be detected by the signal detector (DET) 196C shown in FIG. 17, the signal detector (DET) 196C cannot detect the differential unbalance detection signal. In this case, although an unbalance occurs in the HDMI cable, the unbalance cannot be detected, and hence the cable is erroneously determined as a suitable product. In FIG. 5, the frequency band of the additional signal overlaps with that of the differential signal. In FIG. 18, however, the HPF characteristics do not overlap with the LPF characteristics. This is because the object is not to decode the differential signal information but to detect the differential signal level, and erroneous detection due to overlap of the signal bands is to be reduced.

Therefore, the amplitude of the additional-side receiving signal is compared with that of the differential-side receiving signal, the amplitude of the differential-side receiving signal is corrected to the same level as the amplitude A1 of the additional-side receiving signal as shown in FIG. 18B, and the signal correction amount is supplied also to the gain controller (GC) 193B from the gain controller (GC) 193A shown in FIG. 17 to correct the signal level, whereby also the amplitude of the differential unbalance detection signal is similarly corrected. Consequently, the amplitude A3 before the correction is corrected to an amplitude A4 which is higher than the lower limit A0 of the amplitude which can be detected by the signal detector 196C.

According to the fourth embodiment which has been described above, even in the case where the amplitude of the differential unbalance detection signal is lowered in accordance with the signal attenuation, the differential-side receiving signal and differential unbalance detection signal which are attenuated are corrected in reference to the level of the additional signal which is transmitted through the same HDMI cable. Therefore, the suitability of the HDMI cable can be accurately determined.

### Fifth Embodiment

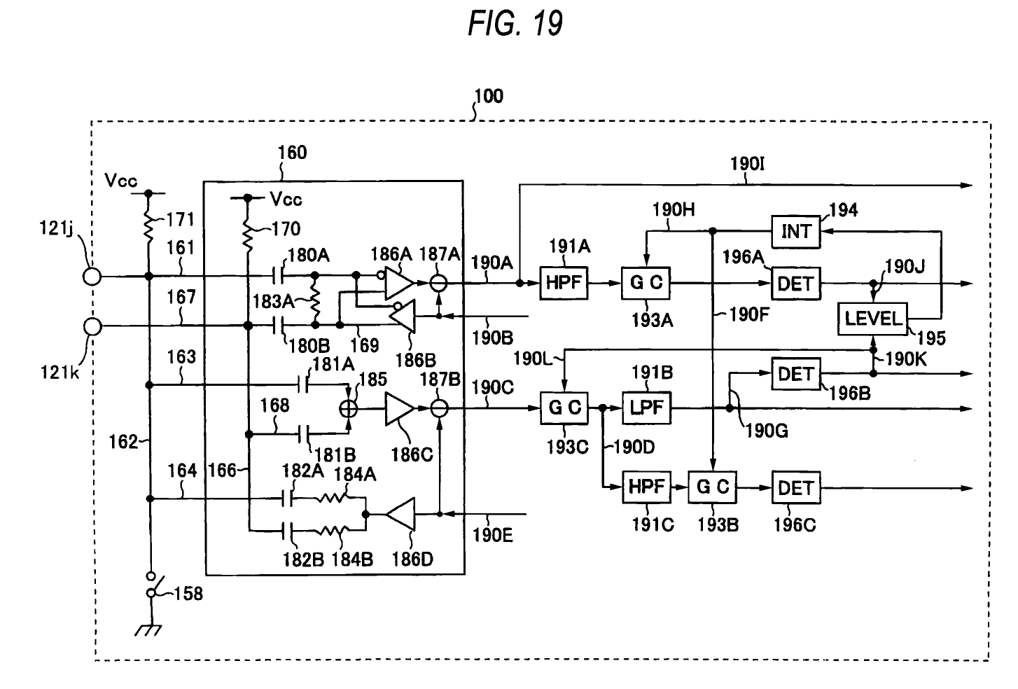

FIG. 19 is a diagram showing the configuration of an HDMI communication interface in a fifth embodiment. The HDMI communication interface 100 performs correction of the amplitude of the additional-side receiving signal before the differential unbalance detection, in addition to the operation of the fourth embodiment, and has: a signal line 190F which is connected to the signal line 190H, and through which the output of the integrator (INT) 194 is supplied to the gain controller (GC) 193B; and a gain controller (GC) 193C which is disposed in the signal line 190C in the front side of the LPF 191B and the HPF 191C, and which performs a gain control based on the level of the additional-side receiving signal detected by the signal detector (DET) 196B.

According to the fifth embodiment which has been described above, the amplitude of the additional-side receiving signal based on the additional-side receiving signal which is corrected to a specified level. Therefore, an erroneous determination of the suitability due to the difference in transmission characteristics of the HDMI cable in the low band can be reduced.

### Sixth Embodiment

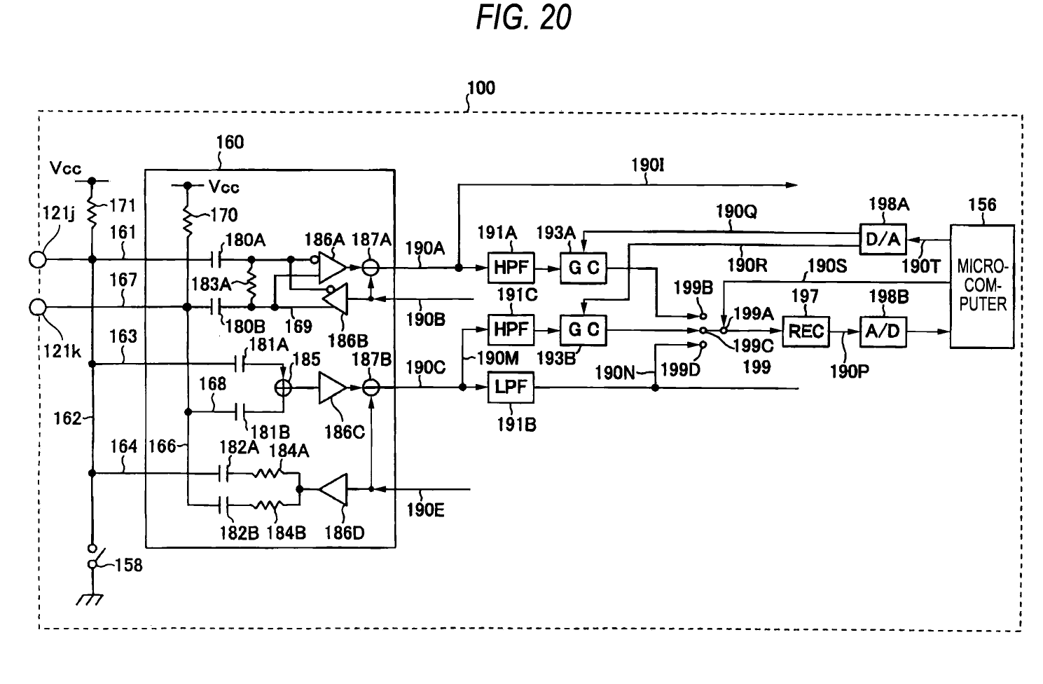

FIG. 20 is a diagram showing the configuration of an HDMI communication interface in a sixth embodiment. The HDMI communication interface 100 performs detection by supplying the differential-side receiving signal, the additional-side receiving signal, and the differential unbalance detection signal to the microcomputer 156 in a time divisional manner by switching of a switch 199.

The switch 199 has a movable terminal 199A which is driven by the microcomputer 156 that is connected to the switch through a signal line 190S. The movable terminal 199A is connected to a signal line 190P. A rectifier (REC) 197 which shapes the signal wave pattern, and an analog/digital converter (A/D) 198B are disposed in the signal line 190P, and connected to the microcomputer 156. A stationary terminal 199B is connected to the signal line 190A for the differential-side receiving signal, and the HPF 191A and the gain controller (GC) 193A are disposed in the signal line 190A. A stationary terminal 199C is connected to a signal line 190M which branches off from the signal line 190C for the additional-side receiving signal, and the HPF 191C and the gain controller (GC) 193B are disposed in the signal line 190M. A stationary terminal 199D is connected to a signal line 190N which branches off from the signal line 190C for the additional-side receiving signal.

The microcomputer 156 is connected to a digital/analog converter (D/A) 198A through a signal line 190T. The digital/analog converter (D/A) 198A is connected to the gain controllers (GC) 193A, 193B through signal lines 190Q, 190R, and controls the gains of the gain controllers (GC) 193A, 193B based on the signal correction amount which is supplied from the microcomputer 156.

In the HDMI communication interface 100, the movable terminal 199A of the switch 199 is first connected to the stationary terminal 199D to detect a first level of the additional-side receiving signal, and, when the movable terminal 199A of the switch 199 is connected to the stationary terminal 199B, the differential-side receiving signal is supplied to the microcomputer 156 via the rectifier (REC) 197 and the analog/digital converter (A/D) 198B to be compared so that a second level of the differential-side receiving signal becomes equal to the first level of the additional-side receiving signal. A control amount is output from the microcomputer 156 via the digital/analog converter (D/A) 198A to control the gains of the gain controllers (GC) 193A, 193B. When the gains become equal to each other, the movable terminal 199A of the switch 199 is connected to the stationary terminal 199C to detect the level of the differential signal which leaks into the additional-side receiving signal. At this time, when the level of the differential signal is not higher than a certain fixed value, it is possible to determine that the cable can be determined as a cable which is for communication, and in which a balance is attained.

According to the sixth embodiment which has been described above, in the correction of the differential-side receiving signal and differential unbalance detection signal which are attenuated, even when the microcomputer 156 disposed in the HDMI communication interface 100 is used, the suitability of the HDMI cable can be accurately determined. In the case of a test communication in which only a carrier wave is transmitted and received in a time divisional manner as shown in FIG. 11, particularly, the present system which can store digital quantities can attain a further excellent accuracy.

The present invention is not limited to the above-described embodiments. Various modifications can be made without departing from or changing the scope of the present invention.

In comparing signal levels, for example, the reception level of S/PDIF communication is used as the reference as described above. Alternatively, the transmission level at the frequency may be used as the reference.

As described with reference to the embodiments, there is provided a data transmission apparatus that is able to, while inheriting the existing cable connection, allow the user to easily determine whether the apparatus is suitable for a new data transmission system or not.

What is claimed is:

1. A data transmission apparatus comprising:
a communication interface comprising:
a first communication interface configured to receive first signals that are transmitted through a communication line having a pair of first and second lines, the first signals being transmitted through the first and second lines in opposite phase; and
a second communication interface configured to receive second signals that are transmitted through the communication line, the second signals being transmitted through the first and second lines in same phase;
a signal detector configured to detect an unbalanced signal that appears as one of:
a first signal component in the second signals that are received by the second communication interface; and
a second signal component in the first signals that are received by the first communication interface; and
a notification module configured to notify an occurrence of an unbalance in the communication line when a level of the unbalanced signal detected by the signal detector is higher than a given value.

2. The apparatus of claim 1, wherein the first communication interface receives the first signals of a first frequency band, and
wherein the second communication interface to receive the second signals of a second frequency band that is different from the first frequency band.

3. The apparatus of claim 1, wherein the second communication interface to separate the first signal component from a signal including the first and second signals received through the communication line.

4. The apparatus of claim 1, wherein the first communication interface to separate the second signal component from a signal including the first and second signals received through the communication line.

5. The apparatus of claim 1, wherein the communication line is configured to transmit the first signals of a first frequency band and the second signals of a second frequency band that is partly overlapped with the first frequency band, and
wherein the communication line is configured to transmit the first and second signals between the first and second communication interfaces.

6. The apparatus of claim 1, wherein the communication interface is configured to transmit the first and second signals in a predetermined sequence by using transmission or reception timing of control information that is transmitted through the first or second line, as a trigger, and
wherein the communication interface is configured to perform, based on received states of the first and second signals, determination of availability of communication by the first signals, determination of availability of communication by the second signals, and determination of the occurrence of the unbalance in the communication line.

7. The apparatus of claim 1, wherein the communication interface is configured to perform determination of the occurrence of the unbalance in the communication line by a correction signal obtained by correcting signal level of the first or second signals.

8. The apparatus of claim 1, wherein the communication interface is configured to perform determination of the availability of communication by the first signals, determination of the availability of communication by the second signals, and determination of the occurrence of the unbalance in the communication line by operating to:
transmit the first or second signals through the communication line to a counterpart apparatus at an arbitrary timing in a state where the communication line is not busy in performing communication; and
receive the first or second signals through the communication line from the counterpart apparatus.

9. A data transmission apparatus comprising:
a communication interface comprising:
a first communication interface configured to receive first signals that are transmitted through a communication line having a pair of first and second lines, the first signals being transmitted through the first and second lines in opposite phase; and
a second communication interface configured to receive second signals that are transmitted through the communication line, the second signals being transmitted through the first and second lines in same phase;
a signal detector configured to detect signal level of the first or second signals received by the communication interface; and
a notification module configured to notify whether or not a counterpart apparatus connected through the communication line is capable of communication by the first or second signals.

10. The apparatus of claim 9, wherein the first communication interface is configured to receive the first signals of a first frequency band, and
wherein the second communication interface is configured to receive the second signals of a second frequency band that is different from the first frequency band.

11. The apparatus of claim 9, wherein the communication line is configured to transmit the first signals of a first frequency band and the second signals of a second frequency band that is partly overlapped with the first frequency band, and
wherein the communication line is configured to transmit the first and second signals between the first and second communication interfaces.

12. The apparatus of claim 9, wherein the communication interface configured to transmit the first and second signals in a predetermined sequence by using transmission or reception timing of control information that is transmitted through the first or second line, as a trigger, and
wherein the communication interface is configured to perform, based on received states of the first and second signals, determination of availability of communication by the first signals, determination of availability of communication by the second signals, and determination of the occurrence of the unbalance in the communication line.

13. The apparatus of claim 9, wherein the communication interface is configured to determine that the counterpart apparatus is not capable of the communication by the first or second signals when the first or second signals are not received from the counterpart apparatus and controls the notification module to indicate that the communication is unavailable.

14. The apparatus of claim 9, wherein the communication interface is configured to perform determination of the availability of communication by the first signals, determination of the availability of communication by the second signals, and determination of the occurrence of the unbalance in the communication line by operating to:
transmit the first or second signals through the communication line to the counterpart apparatus at an arbitrary timing in a state where the communication line is not busy in performing communication; and
receive the first or second signals through the communication line from the counterpart apparatus.

15. A data transmission apparatus comprising:
a first communication interface configured to receive first signals that are transmitted through a communication line having a pair of first and second lines, the first signals being transmitted through the first and second lines in opposite phase;
a second communication interface configured to receive second signals that are transmitted through the communication line, the second signals being transmitted through the first and second lines in same phase; and
a control information communication interface configured to transmit and receive control information through one of the first and second lines,
wherein the first and second communication interfaces are configured to transmit at least one of the first and second signals in a predetermined sequence by using transmission or reception timing of the control information as a trigger to perform determination of availability of communication by the first signals, determination of availability of communication by the second signals, and determination of the occurrence of the unbalance in the communication line.

16. A data transmission apparatus comprising:
a first communication interface configured to receive first signals that are transmitted through a communication line having a pair of first and second lines, the first signals being transmitted through the first and second lines in opposite phase;
a second communication interface configured to receive second signals that are transmitted through the communication line, the second signals being transmitted through the first and second lines in same phase;
a first level detector configured to receive the first signals and detects a signal level of the received first signals; and
a second level detector configured to receive the second signals and detects a signal level of the received second signals,
wherein the first and second communication interfaces are configured to transmit, based on the signal levels of the first and second signals, at least one of the first and second signals at an arbitrary timing in a state where the communication line is not busy in performing communication to perform determination of availability of communication by the first signals, determination of availability of communication by the second signals, and determination of the occurrence of the unbalance in the communication line.
